(19) United States
(12) Patent Application Publication
(10) Pub. No.: US 2017/0002606 A1
(43) Pub. Date: Jan. 5, 2017

(54) CURTAIN RAIL

(71) Applicant: ARLINEA INDUSTRIES CO., Taoyuan City (TW)

(72) Inventor: Yu-Heng YU, Taoyuan City (TW)

(21) Appl. No.: 15/200,618

(22) Filed: Jul. 1, 2016

(30) Foreign Application Priority Data
Jul. 2, 2015 (TW) 104210700

(51) Int. Cl. E06B 9/36; A47H 13/04; A47H 1/04

(52) U.S. Cl. CPC E06B 9/36; A47H 1/04; A47H 13/04; A47H 2001/003

(57) ABSTRACT

A curtain rail includes a tube and a decoration bar. A rail groove allowing hooks arranged therein is defined on a side of the tube. The rail groove extends along a longitudinal direction of the tube, and a latch structure is protruded on another side of the tube. At least an assembling groove corresponding to the latch structure is defined on a lateral surface of the decoration bar and the assembling groove extends along a longitudinal direction of the decoration bar. The latch structure is detachably inserted in the assembling groove and the decoration bar is thereby detachably assembled with tube. The decoration bar is fixed on the tube by embedding the latch structure into the decoration bar, and the tube thereby could be completely shielded by the decoration bar.

### BACKGROUND OF THE INVENTION

Technical Field

The present disclosure is related to a curtain rail, particularly to a curtain rail having a replaceable decoration bar.

Description of Related Art

In general, curtains are hung on a curtain rail, and a conventional curtain rail is a functional element without exterior design. Therefore, the curtain rail does not match with exterior of the curtain and does not look attractive. This problem is usually resolved by arranging decorations to shield the curtain rail and additional costs are therefore resulted.

In views of this, in order to overcome the above disadvantage, the present inventor studied related technology and provided a reasonable and effective solution in the present disclosure.

### SUMMARY

A curtain rail having a replaceable decoration bar is provided in the present disclosure.

A curtain rail for arranging multiple hooks movably thereon is provided in the present disclosure. The curtain rail includes a tube and a decoration bar. A rail groove for arranging the hooks therein is defined on a side of the tube and the rail groove is arranged extending along a longitudinal direction of the tube, a latch structure is arranged protruding on another side of the tube. At least an assembling groove corresponding to the latch structure is defined on a lateral surface of the decoration bar and the assembling groove is arranged extending along a longitudinal direction of the decoration bar. The latch structure is detachably inserted in the assembling groove and the decoration bar is thereby detachably assembled with tube.

Preferably, the assembling groove is a dovetail groove, and the latch structure is a dovetail latch corresponding to the dovetail groove. The latch structure includes a couple of inclined plates arranged at interval, each inclined plate is divergently protruding from the tube, and the inclined plates are extending on the tube along the longitudinal direction of the tube and parallel with each other. A couple of assembling grooves could be defined on the decoration bar, and each inclined plate is detachably inserted in a corresponding one of the assembling grooves. An installing plan extending along the longitudinal direction of the tube is formed on the tube, and the latch structure is arranged protruding on the installing plane. The installing plane is shielded by the decoration bar. The decoration bar could extend beyond a circumference of the installing plane.

The decoration bar is fixed on the tube by embedding the latch structure into the decoration bar, and the tube thereby could be completely shielded by the decoration bar without expose, and the present disclosure is better looking than conventional curtain rails.

### BRIEF DESCRIPTION OF DRAWING

The present disclosure can be more fully understood by reading the following detailed description of the embodiment, with reference made to the accompanying drawings as follows:

FIG. 1 is an exploded view showing the curtain rail disclosed in the embodiment of the present disclosure.

FIG. 2 is a perspective view showing the curtain rail disclosed in the embodiment of the present disclosure.

FIG. 3 is a usage schematic view showing the curtain rail disclosed in the embodiment of the present disclosure.

FIG. 4 is a lateral sectional view showing the curtain rail disclosed in the embodiment of the present disclosure.

FIG. 5 is a lateral sectional view showing a usage of the curtain rail disclosed in the embodiment of the present disclosure.

FIG. 6 is a schematic view showing another example of the latch structure of the curtain rail disclosed in the present disclosure.

FIG. 7 is a schematic view showing another example of the decoration bar of the curtain rail disclosed in the present disclosure.

FIG. 8 is a schematic view showing another example of the assembling groove of the curtain rail disclosed in the present disclosure.

### DETAILED DESCRIPTION

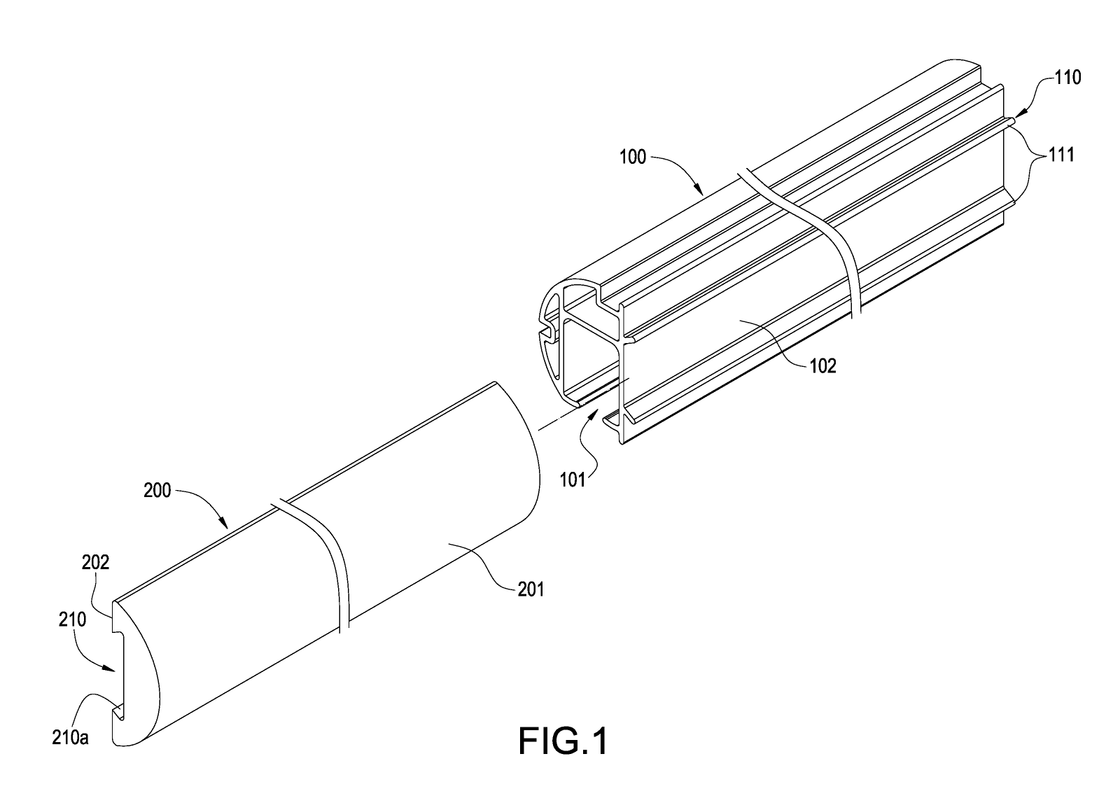

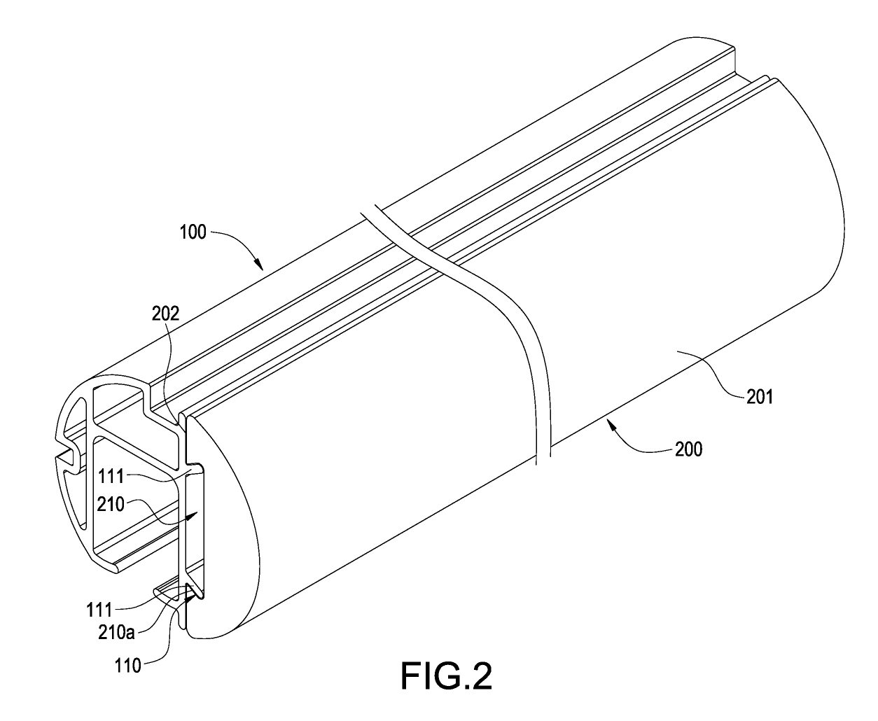

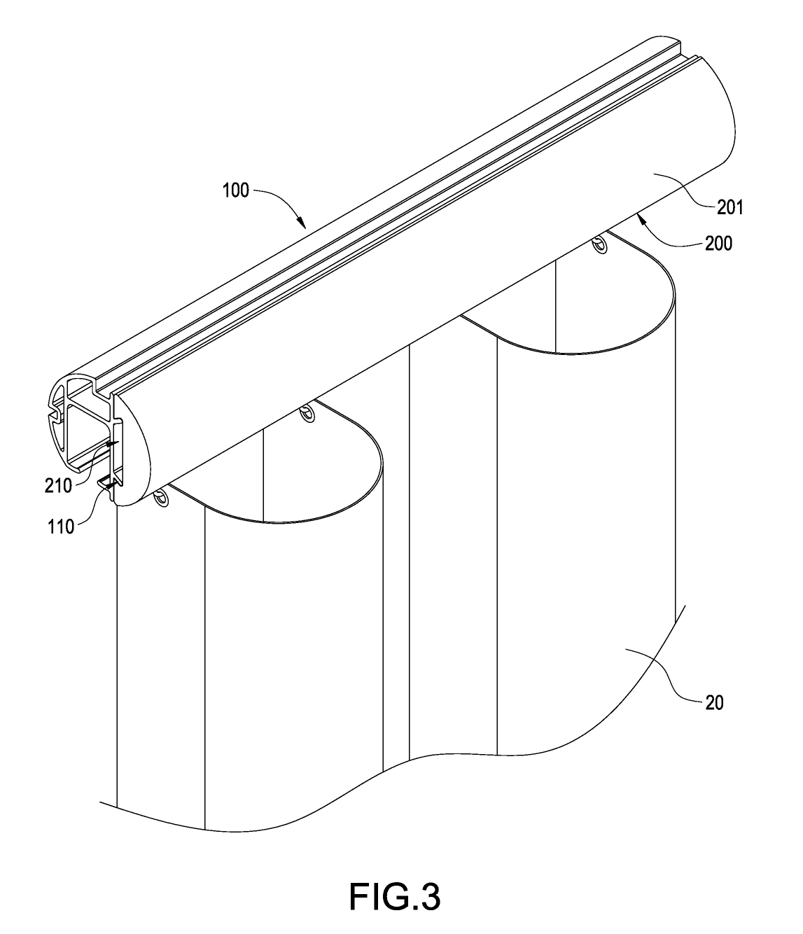

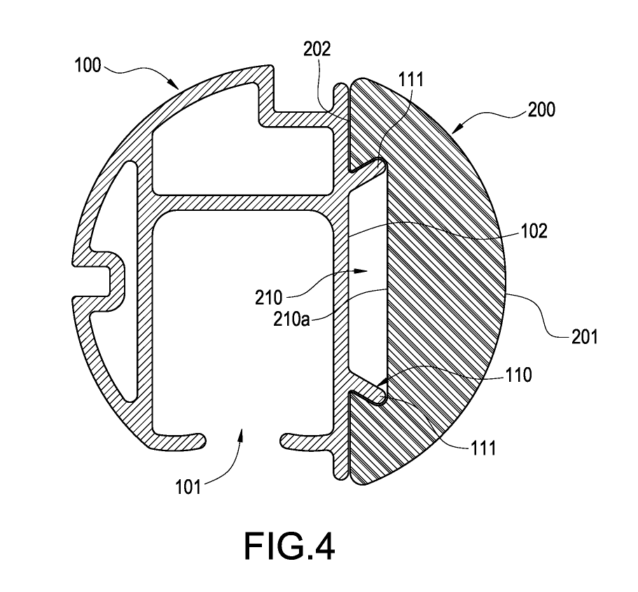

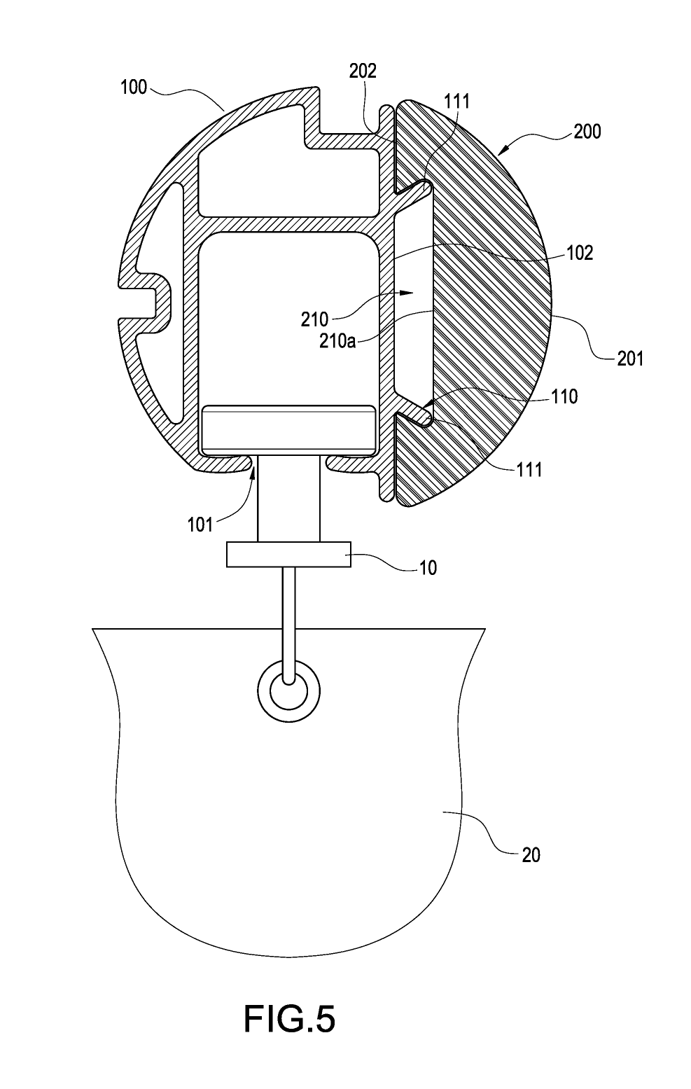

Please refer to FIGS. 1 to 5, a curtain rail is provided in an embodiment of the present disclosure. The curtain rail is installed on a wall for movably arranging multiple hooks 10 thereon. The hooks 10 are used for hanging a curtain 20. In the present embodiment, the curtain rail of the present disclosure includes a tube 100 and a decoration bar 200.

The tube 100 is preferably a metal tube, but this is not a limitation of the present disclosure. A rail groove 101 is defined on a side of the tube 100 and the rail groove 101 is the extending along a longitudinal direction of the tube 100. The rail groove 101 is used for containing the hooks 10. Each of the hooks 10 is movably inserted in the rail groove 101, and is movable along the rail groove 101. An installing plane 102 is defined on another side of the tube 100, and the installing plane 102 is extending along the longitudinal direction of the tube 100. In the present embodiment, the tube 100 is preferably fixed on the wall and arranged horizontally, the rail groove 101 is preferably arranged downward, and the installing plane 102 is preferably arranged upright. A latch structure 110 is arranged protruding on the installing plane 102. The latch structure 110 includes at least a couple of inclined plates 111 arranged at interval, the couple of inclined plates 111 are extending on the installing plane 102 along the longitudinal direction of tube 100 and parallel with each other, the couple of inclined plates 111 are arranged protruding on the installing plane 102 and the couple of inclined plates 111 are divergently protruding.

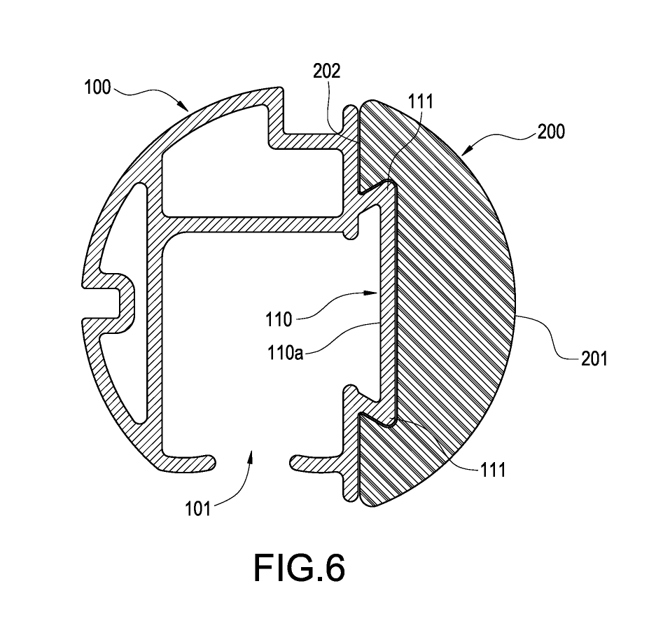

The aforementioned latch structure 110 is a best mold. However, the latch structure 110 is not limited. For example, the latch structure 110 shown in FIG. 6 is a dovetail latch 110a. The dovetail latch 110a has a couple of inclined plates 111 arranged at interval, the couple of inclined plates 111 are arranged extending on the installing plane 102 along the longitudinal direction of the tube 100 and parallel with each other, the couple of inclined plates 111 are arranged on the installing plane 102 and the couple of inclined plates 111 are divergently protruding.

The decoration bar 200 is preferably a flat strip plate, a lateral surface of the decoration bar 200 is an appearance surface 201 with exterior designed, and the other lateral surface opposite thereto is an assembling surface 202. An assembling groove 210 corresponding to the latch structure 110 is defined on the assembling surface 202 of the decoration bar 200 and the assembling groove 210 is extending along a longitudinal direction of the decoration bar 200. The assembling groove 210 is allowing the corresponding latch structure 110 to be embedded therein. In the present embodiment, the assembling groove 210 is preferably a dovetail groove 210a. The latch structure 110 is detachably inserted in the assembling groove 210 and the decoration bar 200 is thereby fixed with the tube 100. The decoration bar 200 could be removed along a longitudinal direction of the assembling groove 210 and thereby disassembled from the tube 100.

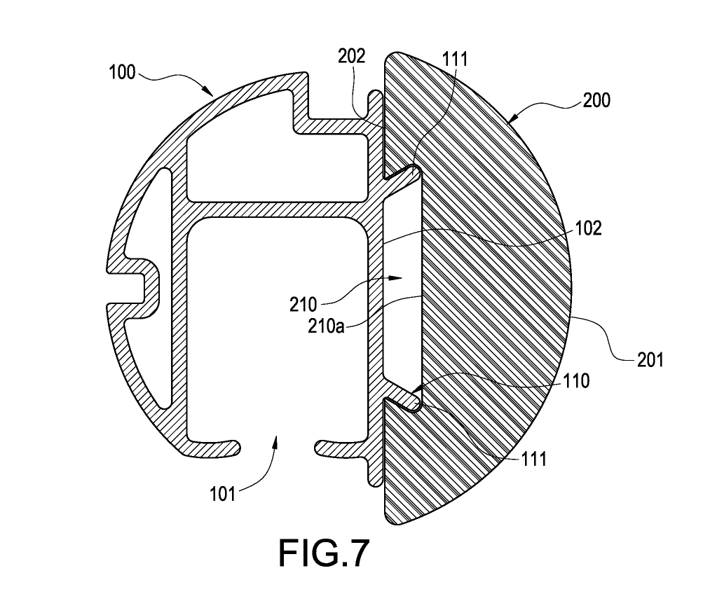

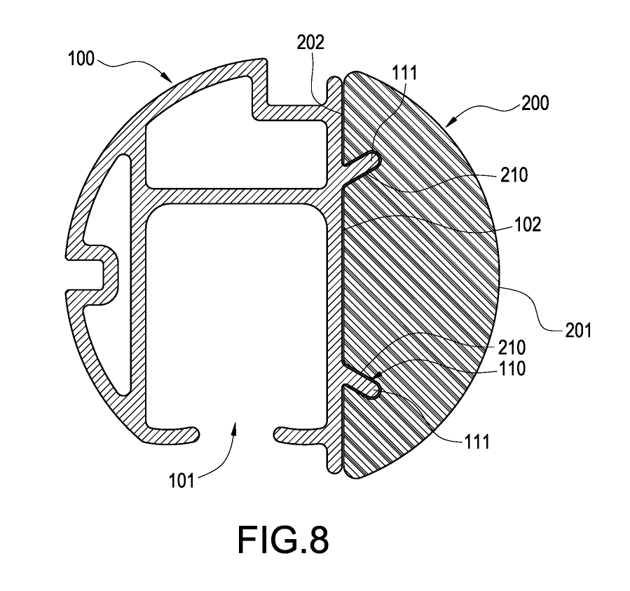

In the present embodiment, size of the decoration bar 200 matches a circumference of the installing plane 102, and the installing plane 102 is thereby shielded, but this is not a limitation of the present disclosure. For example, the decoration bar 200 can extend beyond the circumference of the installing plane 102, shown in FIG. 7, and the tube 100 is thereby assuredly shielded. Moreover, type of the assembling groove 210 is not limited in the present disclosure, for example, a couple assembling grooves 210 are shown in FIG. 8, and the respective inclined plate 111 is detachably inserted in corresponding assembling groove 210.

In the curtain rail of the present disclosure, the decoration bar 200 is fixed on the tube 100 by embedding the latch structure 110 into the decoration bar 200, and the tube 100 thereby could be completely shielded by the decoration bar 200 without expose. An appropriate decoration bar 200 could be selected according to appearance of the curtain and the present disclosure is therefore better looking than conventional curtain rails.

Although the present disclosure has been described with reference to the foregoing preferred embodiment, it will be understood that the disclosure is not limited to the details thereof. Various equivalent variations and modifications can still occur to those skilled in this art in view of the teachings of the present disclosure. Thus, all such variations and equivalent modifications are also embraced within the scope of the present disclosure as defined in the appended claims.

What is claimed is:

1. A curtain rail, for slidably arranging a plurality of hooks thereon, the curtain rail comprising:
a tube, a rail groove for arranging the hooks therein being defined on a side of the tube and the rail groove being extend along a longitudinal direction of the tube, a latch structure being protruded on another side of the tube; and
a decoration bar, at least one assembling groove corresponding to the latch structure being defined on a lateral surface of the decoration bar and the at least one assembling groove being extending along a longitudinal direction of the decoration bar;
wherein the latch structure is detachably inserted in the assembling groove and the decoration bar is thereby detachably assembled with the tube.

2. The curtain rail according to claim 1, wherein the assembling groove is a dovetail groove and the latch structure is a dovetail latch corresponding to the dovetail groove.

3. The curtain rail according to claim 1, wherein the latch structure comprises a couple of inclined plates arranged at interval, the couple of inclined plates are divergently protruding from the tube, and the couple of inclined plates are extending on the tube along the longitudinal direction of the tube and parallel with each other.

4. The curtain rail according to claim 3, wherein a couple of assembling grooves are defined on the decoration bar, and each inclined plate is detachably inserted in the corresponding assembling groove.

5. The curtain rail according to claim 1, wherein an installing plane extending along the longitudinal direction of the tube is formed on the tube, and the latch structure is protruded on the installing plane.

6. The curtain rail according to claim 5, wherein the installing plane is shielded by the decoration bar.

7. The curtain rail according to claim 5, wherein the decoration bar extends beyond a circumference of the installing plane.
